(19) United States
(12) Patent Application Publication
(10) Pub. No.: US 2023/0340985 A1
(43) Pub. Date: Oct. 26, 2023

(54) AXLE LOCKING SYSTEM AND ASSOCIATED INSTALLATION METHODS

(71) Applicant: Amsted Rail Company, Inc., Chicago, IL (US)

(72) Inventor: Brian C. Ford, Moseley, VA (US)

(21) Appl. No.: 17/726,330

(22) Filed: Apr. 21, 2022

(51) Int. Cl. F16B 39/12

(52) U.S. Cl. CPC F16B 39/12

(57) ABSTRACT

A locking ring includes a center portion that forms a center tab extending radially away from a center axis. The locking ring also has a pair of legs that extends away from the center portion in opposite azimuthal directions about the center axis. The center tab fits into a radially-inward-facing annular groove of a lock nut. Each leg has a tab portion that includes one or more radially outward tabs that fit into the annular groove of the lock nut and a locking portion with radially outward teeth that interlock with radially inward teeth of the lock nut. Each radially outward tab forms a chamfered edge that, when the locking ring is inserted into the lock nut, slides against a chamfered edge of the lock nut to engage with the annular groove of the lock nut.

### BACKGROUND

A nut is a piece of hardware that may be threaded onto an axle or spindle to secure a wheel or bearing. When installing the nut, a locking ring may be used to secure the nut and the axle in their locked position to ensure that the nut will not loosen over time.

### SUMMARY

The present embodiments include an axle locking system that may be used in any application that uses a locking ring and a lock nut (e.g., to secure a wheel or bearing onto an axle or spindle). The axle locking system may include (i) one or both of the locking ring and the lock nut disclosed herein, (ii) the locking ring of the present embodiments in combination with a conventional lock nut, and (iii) the lock nut of the present embodiments in combination with a conventional locking ring. The present embodiments also include an installation tool that may be used to install the locking ring.

In a first aspect, a locking ring includes a center portion and a pair of legs. The center portion lies in a first axial plane and forms an outward center tab that extends radially away from a center axis of the locking ring. The outward center tab is shaped to fit into a radially-inward-facing annular groove of a lock nut. The pair of legs is joined to opposite sides of the center portion and extends away from the center portion in opposite azimuthal directions about the center axis. Each leg of the pair of legs has a tab portion and a locking portion. The tab portion lies in the first axial plane and includes one or more radially outward tabs shaped to fit into the annular groove of the lock nut. The locking portion lies in a second axial plane and includes a plurality of radially outward teeth that are shaped to interlock with a plurality of radially inward teeth of the lock nut. Each of the one or more radially outward tabs forms a chamfered edge that, when the locking ring is inserted into the lock nut, slides against a chamfered edge of the lock nut to engage the one or more radially outward tabs with the annular groove of the lock nut.

In a second aspect, a lock nut includes a threaded center hole and an unthreaded center hole. The threaded center hole defines a rotational axis of the lock nut. The unthreaded center hole is coaxial with the threaded center hole and extends axially inward from an end face of the lock nut. The unthreaded center hole forms a chamfered edge with the end face and a radially-inward-facing annular groove located axially inward from the chamfered edge.

In a third aspect, an axle locking system includes a locking ring and a lock nut. The lock nut forms a threaded center hole that defines a rotational axis of the lock nut, and an unthreaded center hole that is coaxial with the threaded center hole and extends axially inward from an end face of the lock nut. The unthreaded center hole includes a radially-inward-facing locking feature and a radially-inward-facing annular groove. The radially-inward-facing locking feature prevents rotation of the locking ring about the rotational axis when engaged with the locking portion of the locking ring. The radially-inward-facing annular groove is located axially inward from the end face.

In a fourth aspect, an installation tool for securing a locking ring into a lock nut includes a cylindrical body and a slot on the cylindrical body. The cylindrical body has a first axial end and a second axial end opposite the first axial end. The first axial end has a flat circular shape sized to fit into an unthreaded center hole of the lock nut. The second axial end has a top surface such that when the top surface is pressed, the first axial end moves into the unthreaded center hole. The slot on the cylindrical body allows locking ring legs to radially extend beyond the cylindrical body. A diameter of the first axial end is less than a diameter of the unthreaded center hole of the lock nut.

### BRIEF DESCRIPTION OF THE FIGURES

FIGS. 1A and 1B illustrate two views of an assembled axle locking system, according to an embodiment.

FIGS. 2A and 2B illustrate two views of a locking ring, according to an embodiment.

FIGS. 3A and 3B illustrate two views of a lock nut, according to an embodiment.

FIGS. 4A and 4B illustrate unthreaded center holes having chamfers, in embodiments.

FIGS. 5A and 5B illustrate an intermediate assembly showing a step of installing a locking ring into a lock nut, according to an embodiment.

FIGS. 6A and 6B illustrate a misaligned axle locking system with a small chamfered overhang on a lock nut, according to an embodiment.

FIGS. 7A, 7B, and 7C illustrate cross-sectional views of example implementations of radially outward tab of a locking ring, in embodiments.

FIG. 8 is a three-dimensional perspective view of an assembled axle locking system, according to an embodiment.

FIG. 9 illustrates a cross-sectional view of assembled axle locking system of FIG. 8.

FIGS. 10A and 10B illustrate an installation tool for installing a locking ring into a lock nut, according to an embodiment.

FIGS. 11A and 11B illustrate an installation tool with one or more tabs to prevent misaligning a locking ring, according to an embodiment.

FIG. 12 illustrates an installed locking ring in a lock nut using an installation tool, according to an embodiment.

FIGS. 13A and 13B illustrate an alternate example of an installation tool, according to an embodiment.

### DETAILED DESCRIPTION

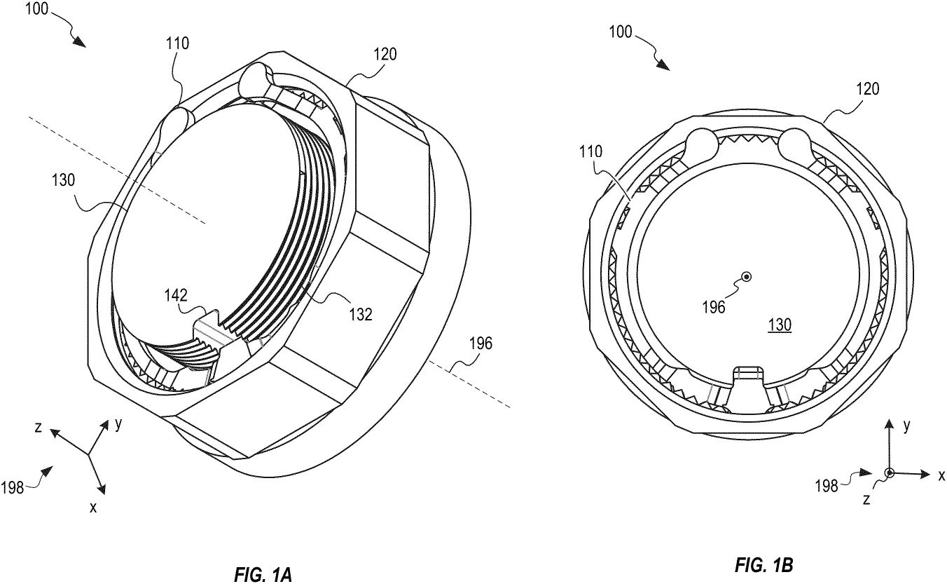

FIGS. 1A and 1B illustrate two views of an Axle locking system 100, according to an embodiment. FIG. 1A is a three-dimensional perspective view of Axle locking system 100. FIG. 1B is a top view of Axle locking system 100. FIGS. 1A and 1B are best viewed together in the following description. Axle locking system 100 includes a lock nut 120 and a locking ring 110. Axle locking system 100 locks an axle 130 to lock nut 120 using locking ring 110 secured to a keyway 142 of axle 130. Lock nut 120 and locking ring 110 are coaxial to a center axis 196, about which lock nut 120 rotates and linearly advances to engage radially outward threads 132 of axle 130. For clarity herein, it is assumed that center axis 196 coincides with the z axis of a right-handed Cartesian coordinate system 198, wherein lock nut 120 translates in the -z direction when engaging with axle 130, and in the +z direction when disengaging from axle 130. In an example operation, lock nut 120 is rotated to tighten onto axle 130. Once tightened, locking ring 110 is installed to keep lock nut 120 from rotating against and disengaging from axle 130.

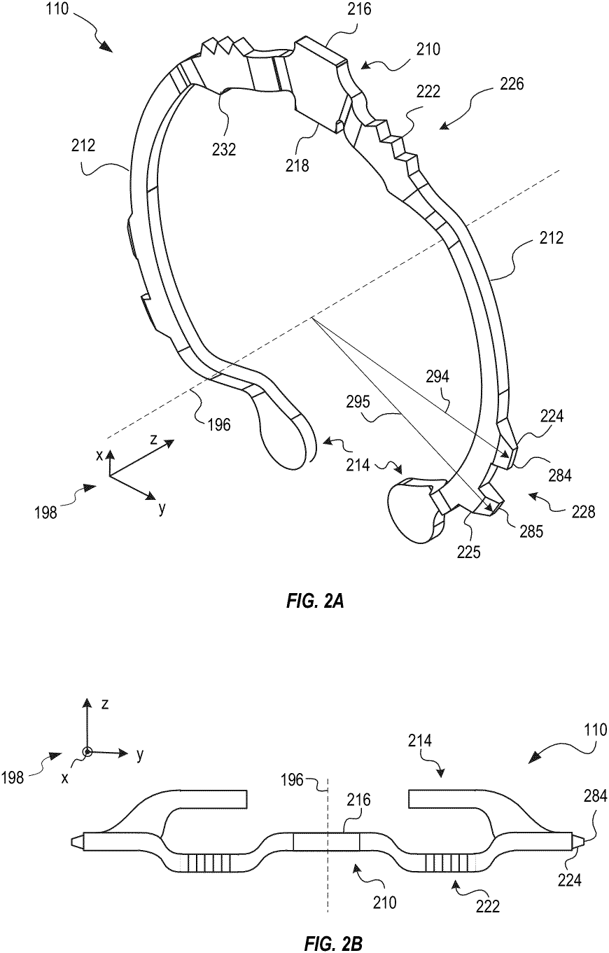

FIGS. 2A and 2B illustrate two views of locking ring 110, according to an embodiment. The view illustrated in FIG. 2A is a three-dimensional perspective of locking ring 110 with center axis 196 of FIG. 1. FIG. 2B illustrates a side view of locking ring 110 in a plane parallel to the y-z plane of coordinate system 198. FIGS. 2A and 2B are best viewed together in the following description. Locking ring 110 includes a center portion 210 and a pair of legs 212. Center portion 210 lies in a first axial plane and has an outward center tab 216 that extends radially away from center axis 196. Outward center tab 216 is shaped to fit into a radially-inward-facing annular groove of a lock nut, such as lock nut 120 of FIG. 1A. Center portion 210 also has an inward center tab 218. Inward center tab 218 extends radially toward center axis 196 and is shaped to engage with a keyway in an axle (e.g., keyway 142 of FIG. 1A). Pair of legs 212 join to opposite sides of center portion 210 and extend away from center portion 210 in opposite azimuthal directions about center axis 196. Each leg 212 includes a tab portion 228 and a locking portion 226. Tab portion 228 lies in the first axial plane and includes one or more radially outward tabs, such as radially outward tabs 224 and 225 shown in FIG. 2A, shaped to fit into the annular groove of the lock nut. Each radially outward tab may have a different radius from the center axis. For example, radially outward tab 224 has a radius 294 from center axis 196 to an outward edge 284 while radially outward tab 225 has a radius 295 from center axis 196 to an outward edge 285. Radii 294 and 295 may have different lengths or the same length. Locking portion 226 lies in a second axial plane and includes a plurality of radially outward teeth 222 shaped to interlock with a plurality of radially inward teeth of a lock nut, such as lock nut 120. In some embodiments, locking portion 226 is located closer to center portion 210 than tab portion 228.

In some embodiments, each of the one or more radially outward tabs 224 and 225 forms a chamfered edge that, as locking ring 110 is inserted into a lock nut, slides against a chamfered edge of the lock nut to engage radially outward tabs 224 and 225 with the annular groove of the lock nut. In embodiments where radially outward tabs 224 and 225 are at different radii (e.g., radii 294 and 295), radially outward tabs 224 and 225 engage at different locations along the chamfered edge of the lock nut. In such embodiments, if locking ring 110 is misaligned during the installation process, one of radially outward tabs 224 and 225 may engage the chamfered edge first and align locking ring 110 correctly in the lock nut. If locking ring is aligned correctly, both of radially outward tabs 224 and 225 engage with the annular groove of the lock nut nearly at the same time.

In certain embodiments, locking ring 110 also includes one or more stiffening tabs 232. For example, each leg 212 may have one stiffening tab 232, as shown in FIG. 2A. Stiffening tabs 232 cause paddles 214 and radially outward tabs 224 to deflect radially inward more than the plurality of radially outward teeth 222 that engage with a lock nut and stiffen locking portion 226. The inward deflection caused by stiffening tabs 232 allows radially outward tabs 224 to click into an annular groove of a lock nut while plurality of radially outward teeth 222 remains engaged with the corresponding plurality of radially inward teeth of the lock nut.

Locking ring 110 may also include, on each leg 212, a paddle 214 at an end opposite to the center portion. Paddle 214 lies in a third axial plane. Paddle 214 may be shaped to be pressed in the -z direction of coordinate system 198 to engage tab portion 228 into an annular groove of a lock nut (e.g., lock nut 120 of FIG. 1A). Paddle 214 may also be squeezed radially inward while being pressed to engage tab portion 228 into a lock nut. When locking ring 110 is fully engaged in a lock nut, paddles 214 in the third axial plane may remain axially outside of an end face of the lock nut.

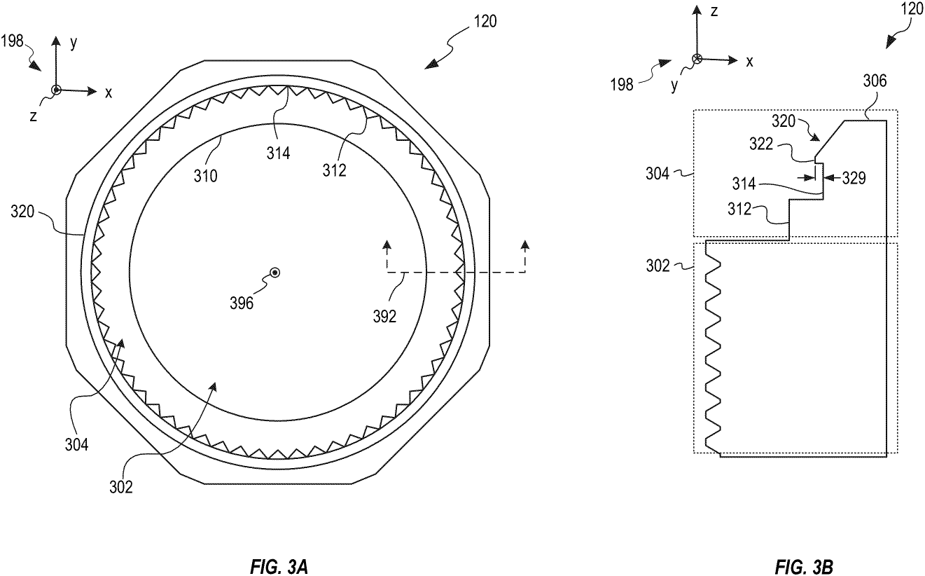

FIGS. 3A and 3B illustrate two views of lock nut 120, according to an embodiment. FIG. 3A is a top view showing an end face 306 of lock nut 120 in a plane parallel to the x-y plane. FIG. 3A denotes a section line 392 that indicates the location of the orthogonal cross-sectional cut-out view of lock nut 120 illustrated in FIG. 3B. FIGS. 3A and 3B are best viewed together in the following description. Lock nut 120 includes a threaded center hole 302 and an unthreaded center hole 304. Lock nut 120 has a rotational axis 396, which is an example of center axis 196 in FIG. 1. Unthreaded center hole 304 is coaxial with threaded center hole 302 and extends axially inward from end face 306 of lock nut 120. Unthreaded center hole 304 includes a radially-inward-facing locking feature 312 and a radially-inward-facing annular groove 314. Locking feature 312 is shaped to prevent rotation of the locking ring about the rotational axis when engaged with a plurality of teeth of a locking ring, such as the plurality of radially outward teeth 222 of FIG. 2A. In an example, locking feature 312 may include a plurality of radially-inward-facing teeth shaped to interlock a plurality of teeth of a locking ring. Annular groove 314 is located axially inward from end face 306 and may be sized to accept one or more radially outward tabs of a locking ring, such as radially outward tabs 224 of FIG. 2A.

In some embodiments, unthreaded center hole 304 also includes a chamfer 320, having a chamfered edge 322, that meets with end face 306 of the lock nut 120. Chamfered edge forms a chamfered overhang 329. Annular groove 314 may be located axially inward from chamfered edge 322.

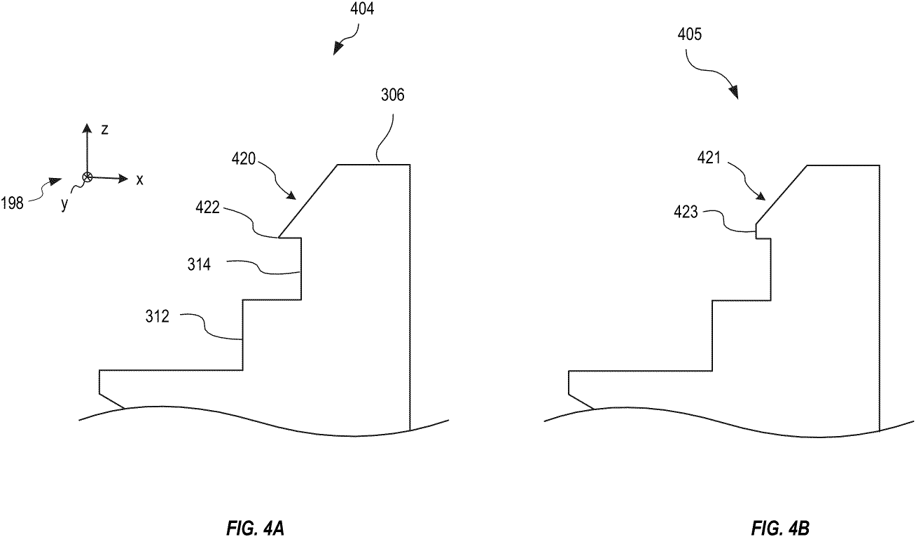

FIGS. 4A and 4B illustrate examples of an unthreaded center hole having chamfers. In FIG. 4A, unthreaded center hole 404, which is an example of unthreaded center hole 304, includes annular groove 314 and locking feature 312. Unthreaded center hole 404 also includes a chamfer 420 having a chamfered edge 422. In this example, chamfered edge 422 is a knife edge. The sharp edge shown in chamfered edge 422 may, in some instances, present a safety hazard for an operator. In an alternate example shown in FIG. 4B, unthreaded center hole 405 includes a chamfer 421 having a chamfered edge 423. Chamfered edge 423 remedies the safety hazard from a sharp edge in chamfered edge 422 by being shaped as a bullnose.

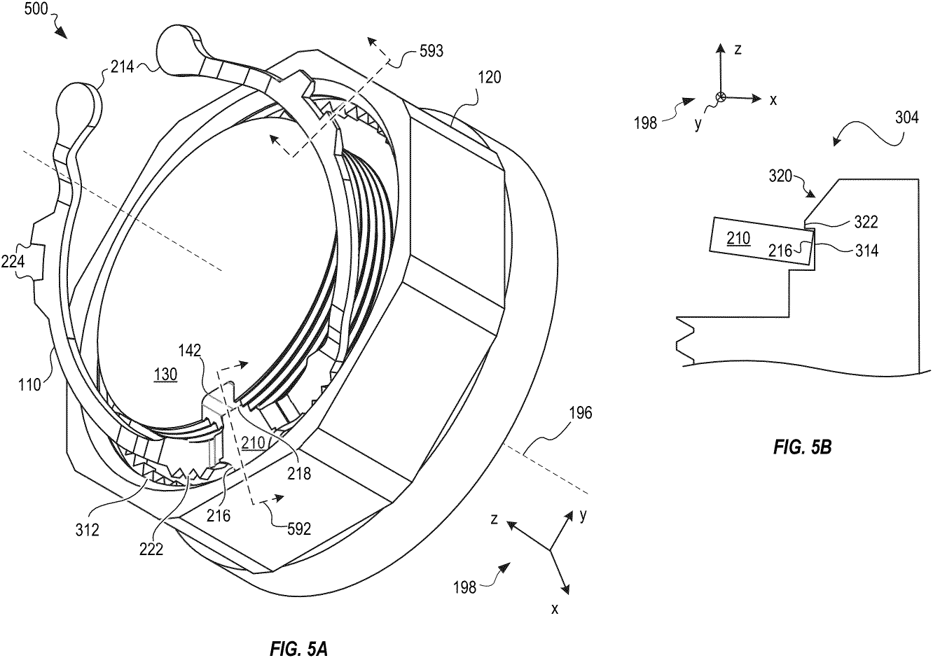

FIGS. 5A and 5B illustrate an intermediate assembly 500 showing a step of installing locking ring 110 into lock nut 120. When the installation of locking ring 110 is complete, intermediate assembly 500 becomes assembled, as shown in FIG. 1A. FIG. 5A is a three-dimensional perspective view with center axis 196. FIG. 5A denotes a section line 592, which indicates the location of the orthogonal cross-sectional view of intermediate assembly 500 illustrated in FIG. 5B. The cross-sectional view of FIG. 5B is on a plane parallel to the x-z plane of coordinate system 198. FIG. 5B illustrates unthreaded center hole 304 of lock nut 120 and center portion 210 of locking ring 110. FIGS. 5A and 5B are best viewed together in the following description. Intermediate assembly 500 shows a step of inserting locking ring 110 after lock nut 120 is tightened onto axle 130.

In one example of installing locking ring 110, after a keyway 142 of axle 130 is located, locking ring 110 is inserted in the -z direction such that inward center tab 218 slides down keyway 142. Outward center tab 216 is then inserted into annular groove 314 of lock nut, as shown in FIG. 5B, while aligning plurality of radially outward teeth 222 of locking ring 110 with the corresponding plurality of teeth of locking feature 312 of lock nut 120, as shown in FIG. 5A. Paddles 214 are then pressed in the -z direction until radially outward tabs 224 are inserted into annular groove 314, preventing axle 130 from rotating about center axis 196. Paddles 214 may also be squeezed radially inward toward center axis 196 to engage radially outward tabs 224 into annular groove 314.

In another example of installing locking ring 110, after locking ring 110 is inserted in the -z direction while inward center tab 218 slides down keyway 142, outward center tab 216 does not need to be inserted into annular groove 314. When paddles 214 are pressed downward, outward center tab 216 and radially outward tabs 224 slide down chamfer 320. As locking ring 110 slides down chamfer 320, each leg 212 of locking ring 110 is radially squeezed inward until outward center tab 216 and radially outward tabs 224 snap into annular groove 314. A hand tool, such as a set of retaining-ring pliers or a flat edge screwdriver, may be used to help install locking ring 110.

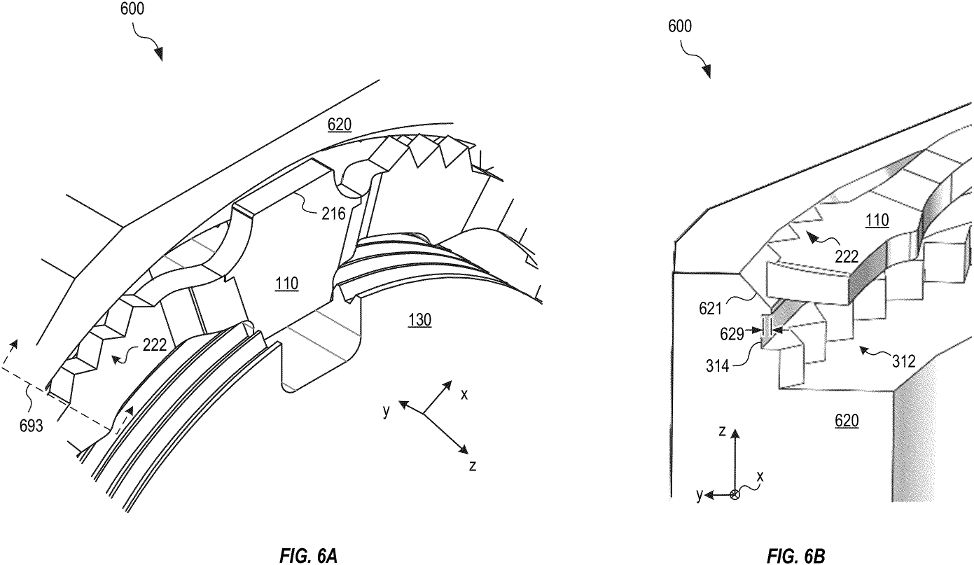

In some examples, a lock nut may not include a chamfer or include a chamfer with a small overhang. The small overhang is typically created to eliminate a sharp edge during machining process. In those examples, chamfered overhang 329 of FIG. 3B may be less than or nearly 0.03 inches. Locking ring 110 may still be used in those examples in the same manner described in FIGS. 5A and 5B. However, a probability of misaligning the locking ring increases with the small overhang on the chamfer. For example, FIGS. 6A and 6B illustrate a misaligned axle locking system 600 with a small chamfered overhang on a lock nut.

FIG. 6A is a three-dimensional perspective view of misaligned axle locking system 600 and denotes a section line 693, which indicates the location of the orthogonal cross-sectional view illustrated in FIG. 6B. FIGS. 6A and 6B are best viewed together in the following description. Misaligned axle locking system 600 includes locking ring 110, axle 130, and a lock nut 620. Lock nut 620 is an example of lock nut 120 and includes a chamfer 621 with a small chamfered overhang 629. Misaligned axle locking system 600 illustrates locking ring 110 with plurality of radially outward teeth 222 disengaged from the corresponding plurality of radially-inward teeth of locking feature 312 of lock nut 620 in the process of installing locking ring 110. When paddles 214 of FIG. 5A are pressed in the -z direction to insert radially outward tabs 224 into annular groove 314, outward center tab 216 may slide upward, disengaging from annular groove 314, and allow plurality of radially outward teeth 222 to disengage from corresponding plurality of radially inward teeth of locking feature 312. To remedy this possible failure, chamfer 621 may be located radially inward toward center axis 196 in FIG. 5A such that chamfered overhang 629 can be lengthened. For example, chamfered overhang 629 may be increased to a range of 0.05 to 0.09 inches.

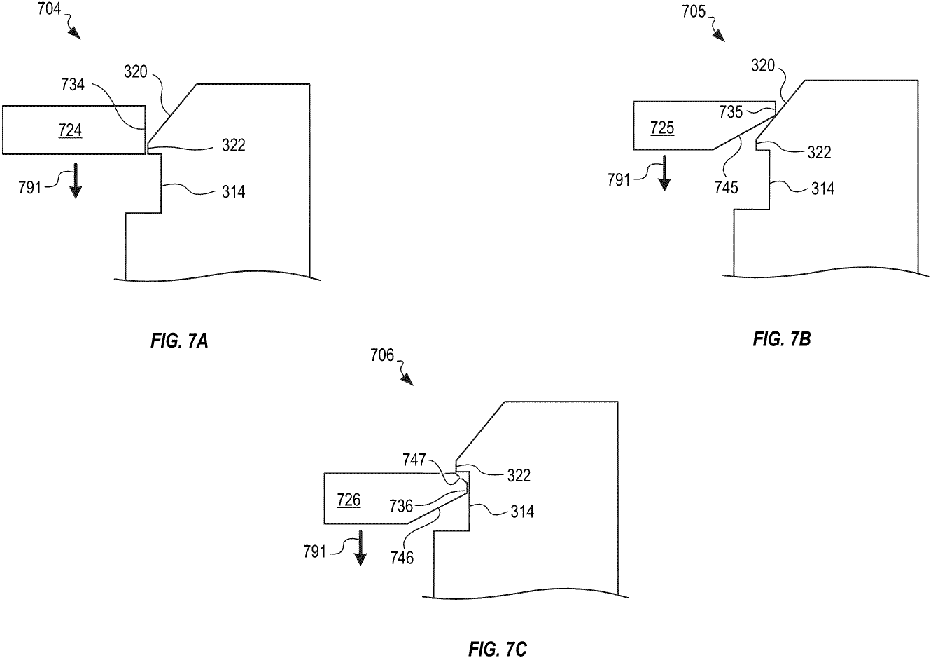

Additionally, one or more radially outward tabs, such as radially outward tab 224 of locking ring 110 may be shaped to improve installing process of locking ring 110. FIGS. 7A, 7B, and 7C illustrate cross-sectional views of example implementations of radially outward tab 224 of locking ring 110 in intermediate assemblies 704, 705, and 706. Intermediate assemblies 704, 705, and 706 show cross-sectional views of unthreaded center hole 304 of lock nut 120 and radially outward tab 224 at a location indicated by a section line 593 in FIG. 5A. Intermediate assembly 704 includes a radially outward tab 724, which is an example of radially outward tab 224 of locking ring 110. Radially outward tab 724 has an interface end 734 that has a rectangular edge. When engaging locking ring 110 into lock nut 120, radially outward tab 724 is pressed in an axial direction 791 toward threaded center hole 302 (not shown for brevity), such that interface end 734 engages annular groove 314. However, in this example, the rectangular edge of interface end 734 may get stuck against chamfered edge 322 before interface end 734 fits into annular groove 314, which may result in locking ring 110 disengaging lock nut 120 during an operation.

In FIG. 7B, intermediate assembly 705 may improve upon intermediate assembly 704 by allowing interface end 734 to better slide against chamfered edge 322. Intermediate assembly 705 includes a radially outward tab 725, which is an example of radially outward tab 224 in FIG. 2A. Radially outward tab 725 has an interface end 735. Interface end 735 has a tapered edge 745. Tapered edge 745 allows interface end 735 to slide down chamfer 320 as radially outward tab 725 is pressed in axial direction 791 and makes a minimal contact with chamfered edge 322. Advantageously, tapered edge 745 forces radially outward tab 725 upward in the +z direction, such that locking ring 110 is pushed axially outward if radially outward tab 725 is not fully inserted in annular groove 314. Tapered edge 745, therefore, remedies the deficiency of interface end 734.

In FIG. 7C, intermediate assembly 706 may further improve upon intermediate assembly 705 by eliminating the minimal contact between interface end 735 and chamfered edge 322 of intermediate assembly 705, which may still cause radially outward tab 725 to get stuck against chamfered edge 322. Intermediate assembly 706 includes a radially outward tab 726, which is an example of radially outward tab 224 in FIG. 2A. Radially outward tab 726 has an interface end 736. Interface end 736 has a first tapered edge 746 and a second tapered edge 747. As with tapered edge 745, first tapered edge 746 allows interface end 736 to slide down chamfer 320 as radially outward tab 725 is pressed in axial direction 791. Additionally, second tapered edge 747 allows radially outward tab 726 to easily engage annular groove 314 as interface end 736 is pressed past chamfered edge 322.

Advantageously, tapered edges 745 and 746 improve the ease of installing the locking ring. Specifically, and as shown in FIG. 7A, as interface end 734 slides downward against chamfer 320 during installation, the sharp edge of interface end 734 can dig into chamfer 320, thereby damaging chamfer 320 or increasing the force required to install radially outward tab 724. By contrast, tapered edges 745 and 746 allow respective radially outward tabs 725 and 726 to slide down chamfer 320 more easily, thereby allowing installation of locking ring 110 by hand.

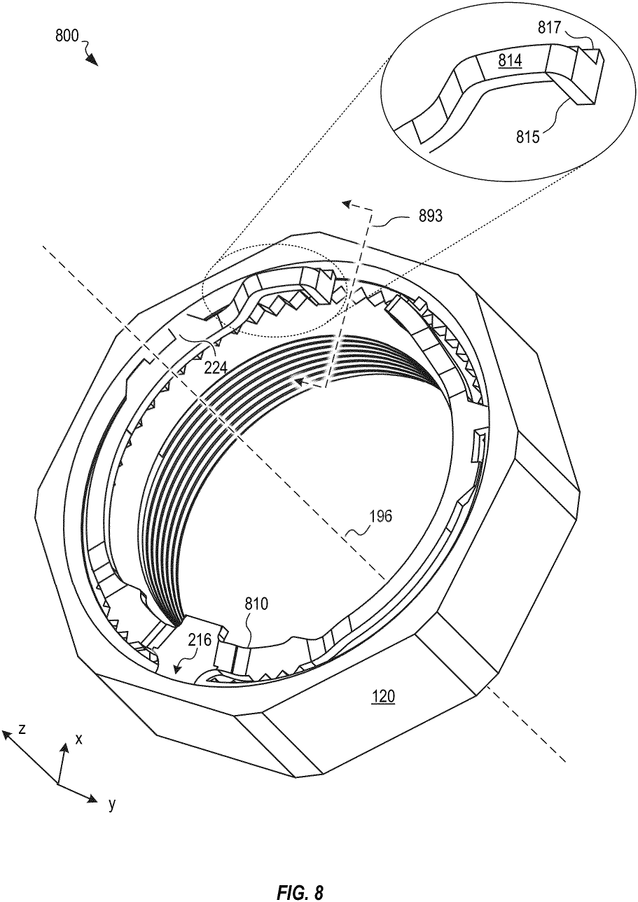

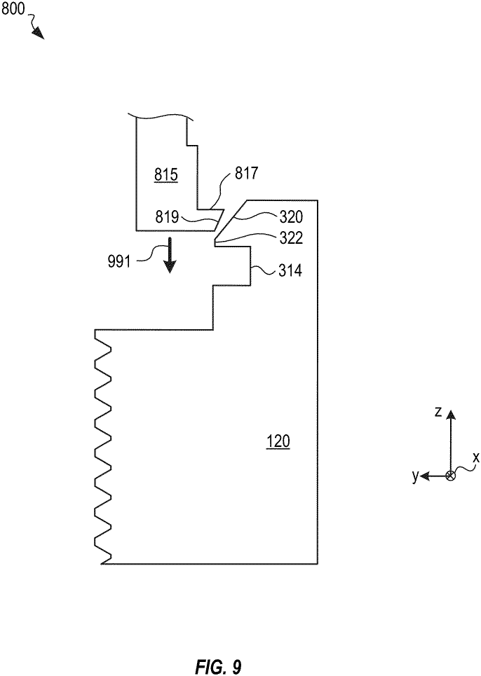

FIG. 8 is a three-dimensional perspective view of an assembled axle locking system 800. Assembled axle locking system 800, having center axis 196, includes axle 130 (not shown for clarity), lock nut 120, and a locking ring 110. Assembled axle locking system 800 has an improvement over Axle locking system 100 for installing locking ring 810 to prevent locking ring 810 from disengaging from lock nut 120. Locking ring 810 is an example of locking ring 110 with addition of a vertical leg 815. FIG. 8 denotes a section line 893, which indicates the location of the orthogonal cross-sectional view illustrated in FIG. 9. FIG. 9 illustrates a cross-sectional view of assembled axle locking system 800 of FIG. 8. FIGS. 8 and 9 are best viewed together in the following description.

Vertical leg 815 extends in the z-direction from an end of paddle 814 to near the first axial plane, where outward center tab 216 and radially outward tabs 224 are located. Vertical leg 815 includes a radially outward tab 817 shaped to engage annular groove 314 of lock nut 120. To engage radially outward tab 817, which locks in locking ring 810 in lock nut 120, paddles 814 can be pressed in downward direction 991. Paddle 814 may also be squeezed radially inward while pressing in downward direction 991. Radially outward tab 817 may have a tapered end 819 that allows radially outward tab 817 to slide down chamfer 320 until radially outward tab 817 engages annular groove 314. Radially outward tab 817 may also have one or more teeth that snap into annular groove 314 when installed correctly. Radially outward tab 817 may be axially located slightly away from the first axial plane, such that radially outward tab 817 and radially outward tabs 224 are not in the same axial plane and have an axial distance between the radially outward tabs 817 and 224. Advantageously, this axial distance allows locking ring 810 to deflect to engage both radially outward tabs 817 and 224. The deflection created forces radially outward tab 817 upward in +z direction, such that locking ring 810 is pushed axially outward if both of radially outward tabs 817 and 224 are not fully inserted in annular groove 314.

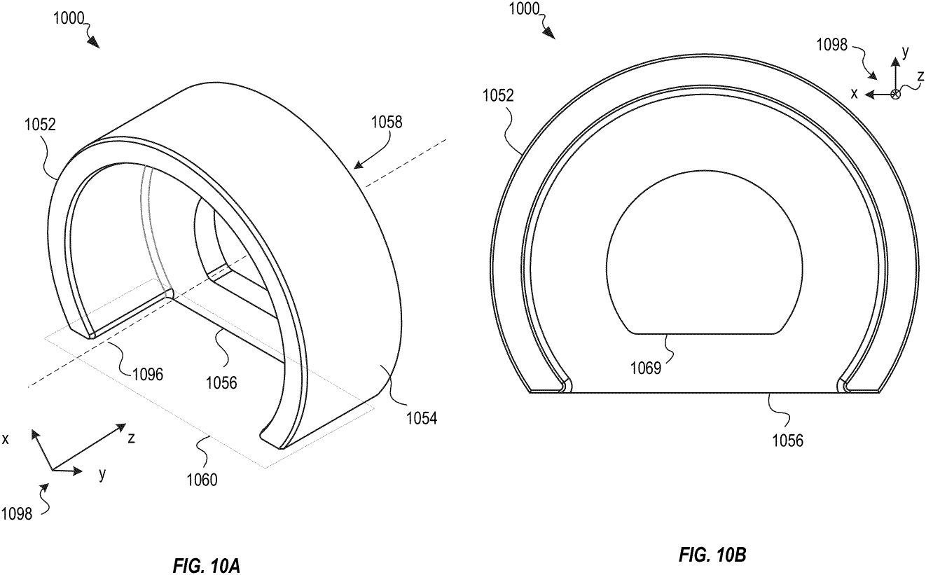

FIGS. 10A and 10B illustrate an installation tool 1000 for installing a locking ring into a lock nut. Installation tool 1000 allows a locking ring, such as locking ring 110, to be installed correctly and easily into a lock nut, such as lock nut 120. The view illustrated in FIG. 10A is a three-dimensional perspective view of installation tool 1000 with a center axis 1096 that defines its rotational axis, which coincides with the z-axis of a right-handed Cartesian coordinate system 1098. FIG. 10B illustrates a bottom view of installation tool 1000 in a plane parallel to a x-y plane of coordinates system 1098. FIGS. 10A and 10B are best viewed together in the following description. Installation tool 1000 includes a cylindrical body 1054 having a first axial end 1052 and a second axial end 1056 opposite first axial end 1052. First axial end 1052 has a flat circular shape sized to fit into an unthreaded center hole of a lock nut, such as unthreaded center hole 304 of lock nut 120. Second axial end 1056 has a top surface 1058. Cylindrical body 1054 has a slot 1060 on the cylindrical body such that the installation tool allows locking ring legs, such as end portions of paddles 214 in FIG. 2A to radially extend beyond cylindrical body 1054. The diameter of first axial end 1052 may be less than the diameter of an unthreaded center hole, such as unthreaded center hole 304 of FIG. 3A of a lock nut. Installation tool 1000 may also include a view port 1069 on second axial end 1056, which allows the operator to view parts underneath installation tool 1000 while using the tool.

In operation, center axis 1096 is aligned with the center axis of a locking ring and a lock nut such that first axial end 1052 sits on top of locking ring 110, for example. Top surface 1058 is then pressed in the -z direction, which moves first axial end 1052 into unthreaded center hole 304 in -z direction. Such movement applies equal axial force on all portions of locking ring 110 until radially outward tabs 224 engage the annular groove of a lock nut, such as annular groove 314 of lock nut 120. In some cases, installation tool 1000 may be pressed too far into a lock nut, misaligning the locking ring. To remedy such cases, installation tool 1000 may have a feature to prevent installation tool 1000 from being pressed too far into a lock nut.

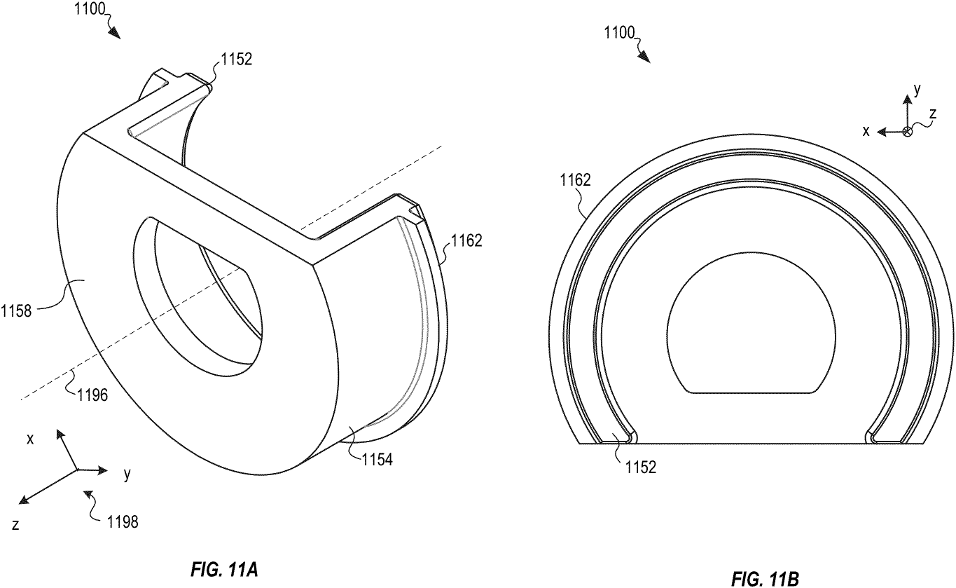

FIGS. 11A and 11B illustrate an installation tool 1100 with one or more tabs to prevent misaligning a locking ring. The view illustrated in FIG. 11A is a three-dimensional perspective view of installation tool 1100 with a center axis 1196 that defines its rotational axis and coincides with the z-axis of a right-handed Cartesian coordinate system 1198. FIG. 11B illustrates a bottom view of installation tool 1100 in a plane parallel to a x-y plane of coordinate system 1198. FIGS. 11A and 11B are best viewed together in the following description. Installation tool 1100, which is an example installation tool 1000, includes one or more tool tabs 1162, a first axial end 1152, a cylindrical body 1154, a second axial end 1158. First axial end 1152, second axial end 1158, and cylindrical body 1154 are examples of first axial end 1052, second axial end 1056, and cylindrical body 1054 of FIG. 10A. Tool tabs 1162 are disposed on an outer cylindrical surface of the cylindrical body 1154. In operation, tool tabs 1162 are shaped to prevent first axial end 1152 to be pressed past an undercut of a chamfer when placed into an unthreaded center hole of a lock nut, such as unthreaded center hole 304 of lock nut 120.

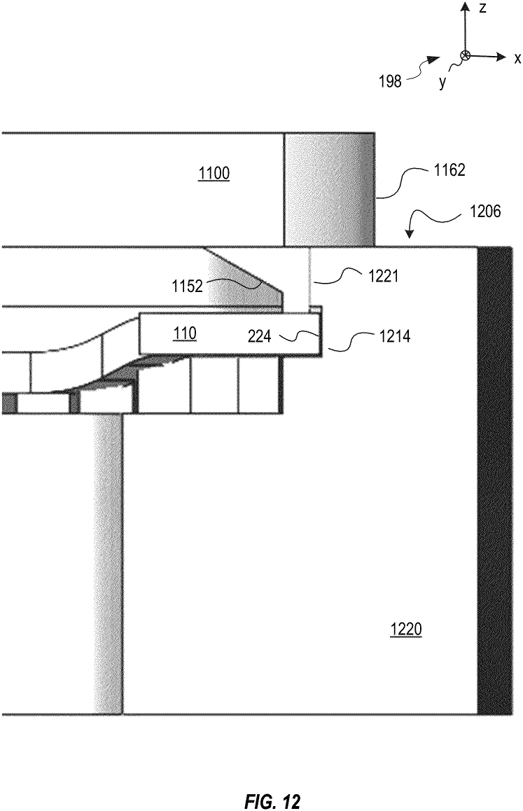

FIG. 12 illustrates an installed locking ring 110 in lock nut 1220 using installation tool 1100. The view shown in FIG. 12 is the same cross-sectional cut-out view of FIG. 3B following coordinate system 198. Lock nut 1220 is an example of lock nut 120 and may or may not have a chamfer 1221. Lock nut 1220 has an end face 1206 and an annular groove 1214, which are examples of end face 306 and annular groove 314. In operation, as installation tool 1100 is pressed downward in the -z direction, radially outward tabs 224 of locking ring 110 are pressed downward and engages annular groove 1214 of lock nut. At the same time, tool tabs 1162 are pressed against end face 1206 and prevent installation tool 1100 from axially advancing radially outward tabs 224 past annular groove 1214 and misaligning locking ring 110 from lock nut 1220. Installation tool 1100, therefore, aids operators in installing locking ring 110 into lock nut 1220 while preventing locking ring 110 from misaligning by having tool tabs 1162.

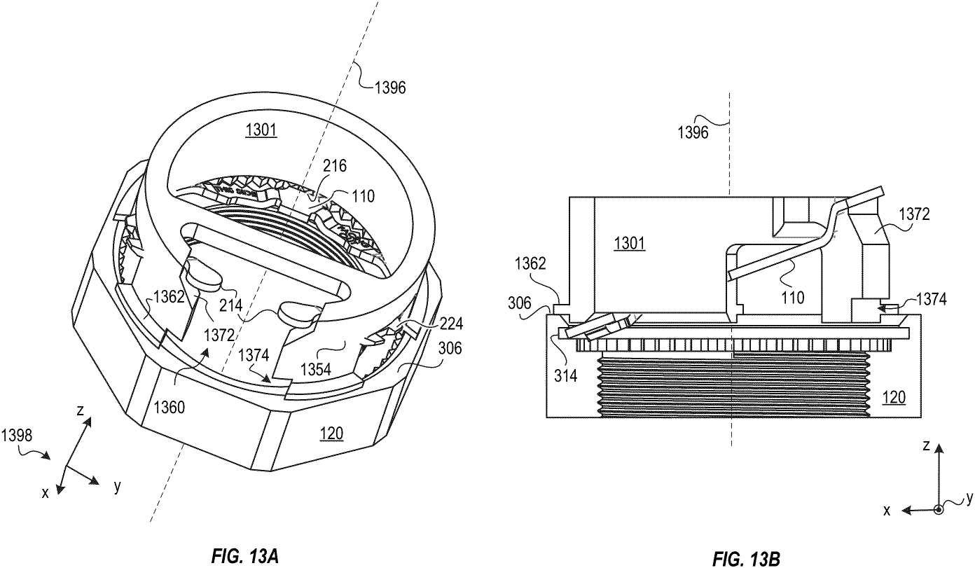

FIGS. 13A and 13B illustrate an alternate example of an installation tool 1301. Installation tool 1301 is an alternate embodiment of installation tool 1100. The view illustrated in FIG. 13A is a three-dimensional perspective of installation tool 1301 with a center axis 1396 that defines its rotational axis, which coincide with the z-axis of a right-handed Cartesian coordinate system 1398. FIG. 13B illustrates a side view of installation tool 1301 in a plane parallel to a x-z plane of coordinates system 1398. FIGS. 13A and 13B are best viewed together in the following description. Installation tool 1301 includes a cylindrical body 1354, a slot 1360 in cylindrical body 1354, and one or more tool tabs 1362, which are examples of cylindrical body 1154, slot 1060 and tool tabs 1162 in FIGS. 10A and 11A. Installation tool 1301 has a slanted portion 1372 in slot 1360. Installation tool 1301 also has a notch 1374.

In operation, after outward center tab 216 is inserted into annular groove 314 of lock nut 120, installation tool 1301 is placed on end face 306 of lock nut 120 with paddles 214 placed on top of slanted portion 1372, as shown on FIGS. 13A and 13B. Tool tabs 1362, which are placed on end face 306, are shaped to keep installation tool 1301 in correct position in z-direction. Slanted portion 1372 allows, when a plurality of paddles of locking ring 110 is pressed toward lock nut 120, the plurality of paddles to be squeezed radially inward and be sprung back to engage a plurality of tabs of the locking ring in an annular groove of the lock nut. For example, as paddles 214 are pressed downward in -z direction, slanted portion 1372 squeezes radially outward tabs 224 radially inward until paddle 214 are snapped into notch 1374, at which point, radially outward tabs 224 are snapped into annular groove 314. Installation tools, such as installation tools 1000, 1100, and 1301, may be made of plastic such as ABS, polypropylene, or polyethylene, and may provide a low-cost way to ensure the correct installation of a locking ring.

Changes may be made in the above methods and systems without departing from the scope of the present embodiments. It should thus be noted that the matter contained in the above description or shown in the accompanying drawings should be interpreted as illustrative and not in a limiting sense. Herein, and unless otherwise indicated the phrase “in embodiments” is equivalent to the phrase “in certain embodiments,” and does not refer to all embodiments. The following claims are intended to cover all generic and specific features described herein, as well as all statements of the scope of the present method and system, which, as a matter of language, might be said to fall therebetween.

What is claimed is:

1. A locking ring comprising:
a center portion lying in a first axial plane and forming an outward center tab that extends radially away from a center axis of the locking ring, the outward center tab being shaped to fit into a radially-inward-facing annular groove of a lock nut; and
a pair of legs joined to opposite sides of the center portion and extending away from the center portion in opposite azimuthal directions about the center axis, each leg of the pair of legs having:
a tab portion lying in the first axial plane and comprising one or more radially outward tabs shaped to fit into the annular groove of the lock nut; and
a locking portion lying in a second axial plane and having a plurality of radially outward teeth shaped to interlock with a plurality of radially inward teeth of the lock nut;
wherein each of the one or more radially outward tabs forms a chamfered edge that, when the locking ring is inserted into the lock nut, slides against a chamfered edge of the lock nut to engage the one or more radially outward tabs with the annular groove of the lock nut.

2. The locking ring of claim 1, each leg having a paddle at an end opposite to the center portion, the paddle lying in a third axial plane.

3. The locking ring of claim 2, the paddle being shaped to be pressed to engage the tab portion into the annular groove of the lock nut.

4. The locking ring of claim 2, the third axial plane remaining axially outside of an end face of the lock nut when the locking ring is engaged with the lock nut.

5. The locking ring of claim 2, the first and the third axial planes being axially biased from the second axial plane in a same direction.

6. The locking ring of claim 2, each leg further comprising a vertical leg extending from an end of the paddle to the first axial plane, the vertical leg having a radially outward tab shaped to engage the annular groove of the lock nut.

7. The locking ring of claim 1, the locking portion being closer to the center portion than the tab portion.

8. The locking ring of claim 1, the center portion comprising an inward center tab that extends radially toward the center axis and is shaped to engage with a keyway in an axle.

9. The locking ring of claim 1, the one or more radially outward tabs comprising two tabs located at different radii from the center axis.

10. A lock nut forming:
a threaded center hole that defines a rotational axis of the lock nut; and
an unthreaded center hole that is coaxial with the threaded center hole and extends axially inward from an end face of the lock nut, the unthreaded center hole forming:
a chamfered edge with the end face; and
a radially-inward-facing annular groove located axially inward from the chamfered edge.

11. The lock nut of claim 10, the unthreaded center hole further forming a plurality of radially-inward-facing teeth shaped to interlock with a plurality of radially-outward teeth of a locking ring.

12. The lock nut of claim 10, the radially-inward-facing annular groove being sized to accept one or more radially outward tabs of a locking ring.

13. The lock nut of claim 10, the chamfered edge being shaped as a bullnose.

14. The lock nut of claim 10, the chamfered edge being a knife edge.

15. An axle locking system, comprising:
the locking ring of claim 1; and
a lock nut.

16. The axle locking system of claim 15, the lock nut forming:
a threaded center hole that defines a rotational axis of the lock nut; and
an unthreaded center hole that is coaxial with the threaded center hole and extends axially inward from an end face of the lock nut, the unthreaded center hole comprising:
a radially-inward-facing locking feature that, when engaged with the locking portion of the locking ring, prevents rotation of the locking ring about the rotational axis; and
a radially-inward-facing annular groove located axially inward from the end face;
wherein the locking ring is sized to fit into the unthreaded center hole of the lock nut.

17. An axle locking system, comprising:
the locking ring of claim 1; and
the lock nut of claim 10.

18. An installation tool for securing a locking ring into a lock nut, comprising:
a cylindrical body having a first axial end and a second axial end opposite the first axial end, the first axial end having a flat circular shape sized to fit into an unthreaded center hole of the lock nut, the second axial end having a top surface such that when the top surface is pressed, the first axial end moves into the unthreaded center hole; and
a slot on the cylindrical body such that the installation tool allows locking ring legs to radially extend beyond the cylindrical body;
wherein a diameter of the first axial end is less than a diameter of the unthreaded center hole of the lock nut.

19. The installation tool of claim 18, further comprising one or more tool tabs that are (i) disposed on an outer cylindrical surface of the cylindrical body and (ii) shaped to prevent the first axial end from being pressed past an undercut of a chamfer when placed into the unthreaded center hole of the lock nut.

20. The installation tool of claim 19, wherein the slot is slanted such that when a plurality of paddles of the locking ring are pressed toward the lock nut, the plurality of paddles is squeezed radially inward and spring back to force a plurality of tabs of the locking ring in an annular groove of the lock nut.

21. The installation tool of claim 18, wherein the first axial end applies an axial force onto the locking ring such that a plurality of tabs of the locking ring engage with an annular groove of the lock nut.

22. The installation tool of claim 18, wherein the second axial end has a view port through which the locking ring can be viewed when the installation tool is placed on top of the locking ring.
